(19) United States
(12) Patent Application Publication
(10) Pub. No.: US 2026/0039465 A1
(43) Pub. Date: Feb. 5, 2026

(54) ENCRYPTION SYSTEM AND METHOD USING HUFF-EDWARDS HYBRID MODEL

(71) Applicant: SAMSUNG ELECTRONICS CO., LTD., Suwon-si (KR)

(72) Inventors: Minhye SEO, Seoul (KR); Suhri Kim, Seoul (KR)

(73) Assignees: SAMSUNG ELECTRONICS CO., LTD., Suwon-si (KR); Duksung Women's University Industry-Academic Cooperation Foundation, Seoul (KR)

(21) Appl. No.: 19/275,106

(22) Filed: Jul. 21, 2025

(30) Foreign Application Priority Data
Aug. 2, 2024 (KR) 10-2024-0103003

(51) Int. Cl. H04L 9/30

(52) U.S. Cl. CPC H04L 9/3066

(57) ABSTRACT

According to an aspect of the present disclosure, an first encryption device using a Huff-Edwards hybrid model includes one or more processors including processing circuitry, and memory storing instructions. The instructions, when executed by the one or more processors individually or collectively, cause the first encryption device to set a plurality of encryption parameters including an elliptic curve and a prime number, calculate a first public key to be shared with a second encryption device based on a secret key, recover a coefficient of a second public key received from the second encryption device, calculate a shared secret curve based on the secret key and the second public key, and establish secure communication between the first encryption device and the second encryption device, based on the first public key and the second public key.

### CROSS-REFERENCE TO RELATED APPLICATIONS

This application claims benefit of priority under 35 U.S.C. § 119 to Korean Patent Application No. 10-2024-0103003, filed on Aug. 2, 2024, in the Korean Intellectual Property Office, the disclosure of which is incorporated by reference herein in its entirety.

### BACKGROUND

### 1. Field

The present disclosure relates generally to encryption devices, and more particularly, to an encryption device for using a Huff-Edwards hybrid model, and a method thereof.

### 2. Description of Related Art

Digital communication may be becoming more common. For example, bank accounts, medical data, and/or other personal and/or sensitive information may be accessed remotely by users. Accordingly, a need for securely maintaining communication channels through which the personal and/or sensitive information may be transmitted and/or received may be increasing.

Cryptography may refer to the study of encrypting and/or decrypting messages, and may be used to provide secure digital communications. Encryption and/or decryption of messages may use one or more keys that may be public and/or private to perform the cryptography.

For example, a public-key encryption device may be used to provide secure digital communications. In a public-key encryption system, a sender may obtain an authenticated public key for a receiver that may have been generated by using a secret key. After obtaining the public key, the sender may encrypt a message with the public key and generate a ciphertext. The receiver may decrypt the ciphertext by using the private key and may extract the message from the decrypted ciphertext. That is, the ciphertext may be incapable of being decrypted when the secret key is not accessible, and thus, only parties with access to the secret key may successfully decrypt the ciphertext.

Recently, along with the development of quantum computers, new encryption technologies may be being developed, such as, but not limited to, encryption algorithms that may be based on elliptic curve cryptography (ECC), which may be secure even on quantum computers.

### SUMMARY

One or more example embodiments of the present disclosure provide an encryption device using a Huff-Edwards hybrid model, which may optimize encryption operations by combining operations on both a Huff curve and an Edwards curve, a method thereof.

According to an aspect of the present disclosure, an first encryption device using a Huff-Edwards hybrid model includes one or more processors including processing circuitry, and memory storing instructions. The instructions, when executed by the one or more processors individually or collectively, cause the first encryption device to set a plurality of encryption parameters including an elliptic curve and a prime number, calculate a first public key to be shared with a second encryption device based on a secret key, recover a coefficient of a second public key received from the second encryption device, calculate a shared secret curve based on the secret key and the second public key, set the elliptic curve to a Huff curve, set the prime number to have a form of 4·l₁·l₂· . . . lₙ−1, lᵢ being an odd prime number, n being a positive integer greater than one, and i being a positive integer less than or equal to n, calculate an isogeny operation by applying a compression function and a square-root Velu formula to the Huff curve, recover, based on the Huff-Edwards hybrid model, a coefficient of an image Huff curve, the image Huff curve being the second public key, and establish secure communication between the first encryption device and the second encryption device, based on the first public key and the second public key.

According to an aspect of the present disclosure, an encryption method using a Huff-Edwards hybrid model to be performed by a first encryption device includes setting a plurality of encryption parameters including an elliptic curve and a prime number, calculating a first public key to be shared with a second encryption device, based on a secret key, recovering a coefficient of a second public key received from the second encryption device, calculating a shared secret curve based on the secret key and the second public key, and establishing secure communication between the first encryption device and the second encryption device, based on the first public key and the second public key. The setting of the plurality of encryption parameters includes setting the elliptic curve to a Huff curve, and setting the prime number to have a form of 4·l₁·l₂· . . . lₙ−1, lᵢ being an odd prime number, n being a positive integer greater than one, and i being a positive integer less than or equal to n. The calculating of the first public key includes calculating an isogeny operation by applying a compression function and a square-root Velu formula to the Huff curve. The recovering of the coefficient of the second public key includes recovering, based on the Huff-Edwards hybrid model, a coefficient of an image Huff curve, the image Huff curve being the second public key.

According to an aspect of the present disclosure, an encryption system includes a first encryption device using a first Huff-Edwards hybrid model, and a second encryption device using a second Huff-Edwards hybrid model. The first encryption device is configured to set a plurality of encryption parameters including an elliptic curve and a prime number, calculate a first public key to be shared with the second encryption device based on a secret key, recover a coefficient of a second public key received from the second encryption device, calculate a shared secret curve based on the secret key and the second public key, and establish secure communication with the second encryption device, based on the first public key and the second public key. The first encryption device is further configured to set the elliptic curve to a Huff curve, and set the prime number to have a form of 4·l₁·l₂· . . . lₙ−1, lᵢ being an odd prime number, n being a positive integer greater than one, and i being a positive integer less than or equal to n. The first encryption device is further configured to calculate an isogeny operation by applying a compression function and a square-root Velu formula to the Huff curve. The first encryption device is further configured to recover, based on the first Huff-Edwards hybrid model, a coefficient of an image Huff curve, the image Huff curve being the second public key.

Additional aspects may be set forth in part in the description which follows and, in part, may be apparent from the description, and/or may be learned by practice of the presented embodiments.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 is a block diagram of an encryption device using a Huff-Edwards hybrid model, according to an embodiment of the present disclosure;

FIG. 2 is an example diagram illustrating an encryption device using a Huff-Edwards hybrid model and another Huff-Edwards hybrid model encryption device exchanging a password, according to an embodiment of the present disclosure;

FIG. 3 is a functional block diagram of a processor of an encryption device using a Huff-Edwards hybrid model, according to an embodiment of the present disclosure; and

FIG. 4 is a flowchart of an encryption method using a Huff-Edwards hybrid model, according to an embodiment of the present disclosure.

### DETAILED DESCRIPTION

Throughout the present disclosure, identical reference numbers may refer to substantially identical components. In the following description, detailed descriptions of components and functions that are not related to the core components of the present disclosure and are known in the technical field of the present disclosure may be omitted for the sake of brevity. The meanings of terms described in the present disclosure should be understood as follows.

The present disclosure may be embodied in various different forms, and should not be construed as being limited only to the illustrated embodiments. Rather, these embodiments are provided as examples such that the present disclosure is thorough and complete, and may convey the present disclosure to those skilled in the art. The present disclosure may be defined by the scope of the claims. The terminology used herein to describe the present disclosure is not intended to limit the scope of the present disclosure.

Shapes, sizes, ratios, angles, numbers, or the like disclosed in drawings for describing embodiments of the present disclosure are examples, and thus the present disclosure is not limited to the illustrated matters. The same reference numerals may denote the same elements throughout the present disclosure. Moreover, in describing the present disclosure, when it is determined that the specific description of the known related art unnecessarily obscures the gist of the present disclosure, the detailed description thereof may be omitted.

Whenever words of “includes,” “has,” “consists of,” or the like are used in the present disclosure, other parts may be added unless “only” is used. When components are expressed in the singular, they may include the plural unless otherwise noted.

Components are to be interpreted to include a margin of error, even when not explicitly stated otherwise.

When a temporal relationship is described (e.g., when a temporal antecedent-following relationship such as “after,” “following,” “next to,” “before,” or the like is described), a case that is not consecutive may be included unless “immediately” or “directly” is used.

Although terms “first”, “second”, or the like, may be used herein to describe various components. However, these components should not be limited by these terms. These terms are only used to distinguish one component from another component. Accordingly, a first component that is discussed below may be termed as a second component without departing from the technical idea of the present disclosure. It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

The term “at least one” should be understood to include any combination capable of being presented from one or more related items. For example, the meaning of “at least one of the first, second, and third items” may mean each of the first, second, or third items, as well as any combination of items capable of being presented from two or more of the first, second, and third items.

Each of the features of the various embodiments of the present disclosure may be combined and/or may be combinable with each other, in part or in whole, and may be technically interlocked and operated in various ways, and each of embodiments may be practiced independently of each other or together in association relationship.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, or the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, an encryption device and an encryption method for using a Huff-Edwards hybrid model according to various embodiments of the present disclosure are described with reference to the accompanying drawings.

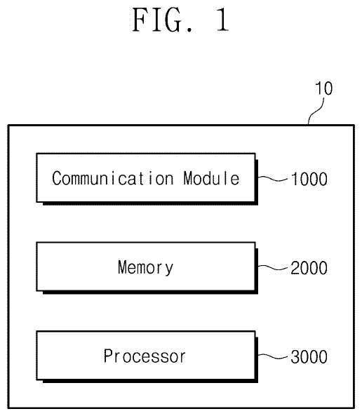

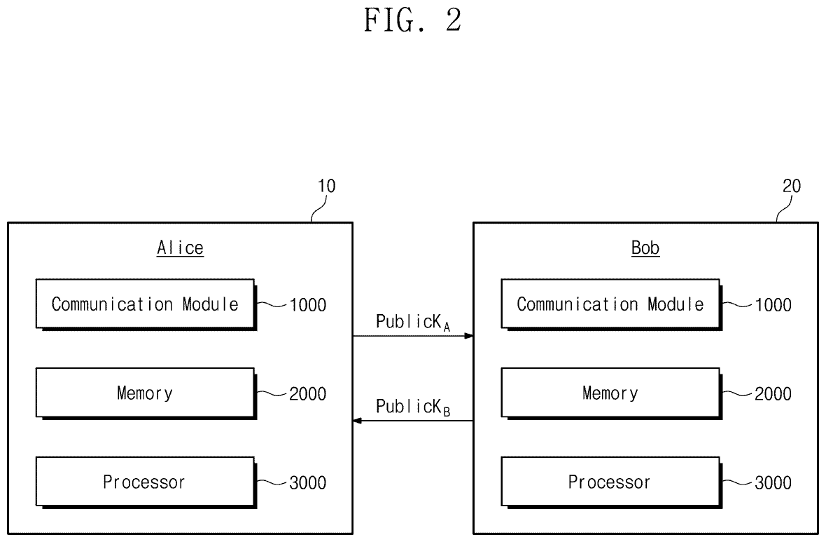

FIG. 1 is a block diagram of an encryption device using a Huff-Edwards hybrid model, according to an embodiment of the present disclosure. FIG. 2 is an example diagram illustrating an encryption device using a Huff-Edwards hybrid model and another Huff-Edwards hybrid model encryption device exchanging a password, according to an embodiment of the present disclosure.

Referring to FIG. 1, a first encryption device 10 using a Huff-Edwards hybrid model, according to an embodiment of the present disclosure, may include a communication module 1000, a memory 2000, and a processor 3000.

The communication module 1000 may allow the first encryption device 10 to transmit and/or receive data with another external device by using the Huff-Edwards hybrid model. For example, as shown in FIG. 2, the external device may be a second encryption device 20 using another Huff-Edwards hybrid model that exchanges public keys (e.g., a first public key PublicK_{A} and a second public key PublicK_{B}), which may be encryption keys. Moreover, data being transmitted and/or received may be a cipher exchanged between the first encryption device 10 using one Huff-Edwards hybrid model and the second encryption device 20 using another Huff-Edwards hybrid model. In an embodiment, the first encryption device 10 may be assigned (e.g., logged in) to a first user (e.g., Alice). Alternatively or additionally, the second encryption device 20 may be assigned (e.g., logged in) to a second user (e.g., Bob). However, the present disclosure is not limited in this regard, and the first encryption device 10 and the second encryption device 20 may be assigned to a same user and/or to other users.

The second encryption device 20 may include and/or may be similar in many respects to the first encryption device 10 described above with reference to FIG. 1, and may include additional features not mentioned above. Consequently, descriptions of the first encryption device 10 may also apply to the second encryption device 20.

For example, the communication module 1000 may be and/or may include a device capable of transmitting and/or receiving various types of information such as, but not limited to, radio frequency (RF) signals, laser signals, wired signals, or the like.

The memory 2000 may be and/or may include hardware for storing various types of data processed in the first encryption device 10 by using a Huff-Edwards hybrid model. For example, the memory 2000 may store pieces of processed data and/or data to be processed by the first encryption device 10 using the Huff-Edwards hybrid model.

The memory 2000 may be and/or may include a random access memory (RAM), such as, but not limited to, a dynamic RAM (DRAM) or a static RAM (SRAM), a read-only memory (ROM), an electrically erasable programmable ROM (EEPROM), a compact-disc ROM (CD-ROM), a Blu-ray disc or any other optical disk storage, a hard disk drive (HDD), a solid state drive (SSD), a flash memory, or the like. However, the present disclosure is not limited thereto.

The processor 3000 may perform overall functions for encryption using the Huff-Edwards hybrid model. For example, the processor 3000 may perform overall control on the first encryption device 10 using the Huff-Edwards hybrid model by executing programs stored in the memory 2000 within the first encryption device 10 and/or the second encryption device 20 using the Huff-Edwards hybrid model.

The processor 3000 may be implemented by one or more processors. For example, the processor 3000 may be implemented as an array of logic gates, and/or may be implemented as a combination of a general-purpose microprocessor and a memory storing a program capable of being executed on the microprocessor. For example, the processor 3000 may be and/or may include a central processing unit (CPU), a graphics processing unit (GPU), a hardware accelerator, or the like.

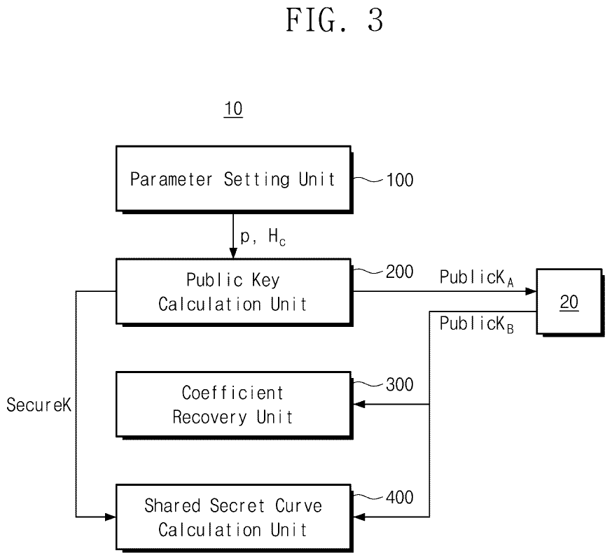

Hereinafter, an encryption device using a Huff-Edwards hybrid model is described with reference to FIG. 3. FIG. 3 is a functional block diagram of an encryption device 10 using a Huff-Edwards hybrid model, according to an embodiment of the present disclosure.

According to an embodiment of the present disclosure, the processor 3000 of the first encryption device 10 (or the second encryption device 20), using a Huff-Edwards hybrid model, may optimize an isogeny operation by applying a square-root Velu formula to an odd-order isogeny operation in a Huff curve. In an embodiment, the processor 3000 of the first encryption device 10 may perform elliptic curve coefficient operation restoration an optimization by using an Edwards curve, thereby potentially improving encryption speed, when compared to a related encryption device.

Referring to FIG. 3, the processor 3000 of the first encryption device 10 using the Huff-Edwards hybrid model, according to an embodiment of the present disclosure, may include a parameter setting unit 100, a public key calculation unit 200, a coefficient recovery unit 300, and a shared secret curve calculation unit 400.

In an embodiment, the parameter setting unit 100, the public key calculation unit 200, the coefficient recovery unit 300, and/or the shared secret curve calculation unit 400 may be physically implemented by analog and/or digital circuits including one or more of a logic gate, an integrated circuit, a microprocessor, a microcontroller, a memory circuit, a passive electronic component, an active electronic component, an optical component, and the like. For example, a field programmable gate array (FPGA) may be used to implement custom logic that may include the functionality of the parameter setting unit 100, the public key calculation unit 200, the coefficient recovery unit 300, and/or the shared secret curve calculation unit 400. As another example, a processor in combination with a memory may be used to execute one or more instructions to perform the functionality of the parameter setting unit 100, the public key calculation unit 200, the coefficient recovery unit 300, and/or the shared secret curve calculation unit 400. Alternatively or additionally, at least a portion of the functionality of the parameter setting unit 100, the public key calculation unit 200, the coefficient recovery unit 300, and/or the shared secret curve calculation unit 400 may be incorporated into the processor 3000 and/or implemented as instructions to be executed by the processor 3000.

The parameter setting unit 100 may set a parameter for applying the present disclosure to a commutative supersingular isogeny Diffie-Hellman (CSIDH) key exchange protocol. For example, the parameter setting unit 100 may set one great prime number p and a Huff curve H_{c}. For example, the one great prime number p may be represented in a form of p=4·l₁·l₂· . . . lₙ−1, where lᵢ may be an odd prime number. The Huff curve H_{c} may be represented as an equation similar to Equation 1.

$${H}_{c} : cx ( {y}^{2} - 1 ) = y ( {x}^{2} - 1 ) \qquad [ Equation 1 ]$$

Referring to Equation 1, c may represent the coefficient of the Huff curve H_{c}, and may be set to a value with a specific condition.

The public key calculation unit 200 may calculate the first public key PublicK_{A} to be shared with the second encryption device 20. The public key calculation unit 200 may define an isogeny operation φ for calculating the first public key PublicK_{A} on the Huff curve H_{c} by using a secret key SecretK of the first encryption device 10, which may be an arbitrary vector. The public key calculation unit 200 may perform the defined isogeny operation φ on the Huff curve H_{c}, and may calculate the first public key PublicK_{A} by mapping points on the Huff curve H_{c} to points on an image Huff curve H_{c′}.

The public key calculation unit 200 may potentially improve the operation speed of the isogeny operation φ by applying the compression function w and the square-root Velu formula to the isogeny operation φ on the Huff curve H_{c}.

The public key calculation unit 200 may map a point Q on the Huff curve H_{c} onto a point φ(Q) on the image Huff curve H_{c′} through the isogeny operation φ and may apply the mapped point to the compression function w.

According to an embodiment, the public key calculation unit 200 may calculate an equation similar to Equation 3 that may have been optimized by using an equation similar to Equation 2, which may represent a polynomial of a finite subset S of a kernel [symbol] P [symbol] of the isogeny operation φ and the compression function w for one point Q on the Huff curve H_{c} depending on the isogeny operation φ and the compression function w on the Huff curve H_{c} by using the square-root Velu formula.

$${h}_{s} ( W ) = {\prod }_{s ∈ S} ( W - ω ( [ s ] p ) ) \qquad [ Equation 2 ]$$

$$w ( φ ( W ) ) = \frac{{W}^{l} {{h}_{s} ( W )}^{2}}{{{h}_{s} ( 1 / W )}^{2}} \qquad [ Equation 3 ]$$

Accordingly, the public key calculation unit 200 may generate the image Huff curve H_{c′} based on an equation similar to Equation 3, may set the generated image Huff curve H_{c′} as the first public key PublicK_{A}, and may share the first public key PublicK_{A} as a password with the second encryption device 20 using another Huff-Edwards hybrid model, as shown in FIG. 2.

The coefficient recovery unit 300 may recover the coefficient of the image Huff curve H_{c′}, which is the second public key PublicK_{B} received from the second encryption device 20 using another Huff-Edwards hybrid model.

That is, the coefficient recovery unit 300 may recover the coefficient c′ of the image Huff curve H_{c′} by using the relationship between the Huff curve H_{c} and the Edwards curve E based on the second public key PublicK_{B} received from the second encryption device 20 using another Huff-Edwards hybrid model. The Edwards curve may be represented as an equation similar to Equation 4.

$${E}_{d} : {x}^{2} + {y}^{2} = 1 + {dx}^{2} {y}^{2} \qquad [ Equation 4 ]$$

In an embodiment, the coefficient recovery unit 300 may recover the coefficient c′ of the image Huff curve H_{c′}, which may be the received second public key PublicK_{B}, by performing calculations on the second public key PublicK_{B} received from the second encryption device 20 using another Huff-Edwards hybrid model in the order of H_{c}→E→E′→H_{c′}.

The coefficient recovery unit 300 may calculate the Edwards curve E, which may be birationally equivalent to the Huff curve H_{c}, through an isomorphism operation ψ, may map the calculated Edwards curve E onto the image Edwards curve E′ through the isogeny operation φ, and may calculate the image Huff curve H_{c′}, which may be birationally equivalent to the mapped image Edwards curve E′, through an isomorphism operation ψ⁻¹. This process may be represented by a composite function ψ⁻¹φψ. Accordingly, the coefficient recovery unit 300 may efficiently recover the coefficient c′ of the image Huff curve H_{c′} for the isogeny operation φ that maps the Huff curve H_{c} onto the image Huff curve H_{c′}, when compared to a related encryption device.

The coefficient recovery unit 300 may calculate a recovery coefficient [symbol] of the image Huff curve H_{c′} using an equation similar to Equation 5 for calculating the recovery coefficient ĉ of the Huff curve H_{c} by using the coefficient c̅ c of the Huff curve H_{c}, an equation similar to Equation 6 for calculating the recovery coefficient [symbol] of the image Huff curve H_{c′} by using the coefficient c′ of the image Huff curve H_{c′}, an equation similar to Equation 7 for calculating the relationship between the coefficient d̅ d of the Edwards curve E̅_̅{̅d̅}̅ E_{d} and the recovery coefficient [symbol] of the image Huff curve H_{c′}, and an equation similar to Equation 8 for calculating the relationship between the coefficient d of the Edwards curve E_{d} and the recovery coefficient ĉ of the Huff curve H_{c}.

$$\hat{c} = \frac{1}{4} ( c + \frac{1}{c} - 2 ) \qquad [ Equation 5 ]$$

$$\hat{{c}^{′}} = \frac{1}{4} ( {c}^{′} + \frac{1}{{c}^{′}} - 2 ) \qquad [ Equation 6 ]$$

$$\hat{{c}^{′}} = \frac{d}{( 1 - d )} \qquad [ Equation 7 ]$$

$$d = {( \frac{\hat{c} + 1}{\hat{c}} )}^{l} {( \frac{{h}_{s} ( 1 )}{{h}_{s} ( - 1 )} )}^{8} \qquad [ Equation 8 ]$$

Accordingly, the above-mentioned isogeny operation amount of odd (l=2s+1)-order may be calculated as shown in Table 1 below.

TABLE 1

| | w | Huff-Edwards |
|---|---|---|
| l-iso eval | 4sM + 2S | 4sM + 2S |
| l-iso coeff | 4sM + 2S | (2s)M + 6S + 2w(l) |

Referring to Table 1, l-iso eval may represent the computational amount for the isogeny operation φ that maps points on one curve to points on another curve. l-iso coeff, as shown in Table 1, may represent the operation amount for recovering the coefficient c′ of the image Huff curve H_{c′}. M may denote a multiplication operation on a finite field, S may denote a square operation on the finite field, and w(l) may denote the hamming weight of l. As shown in Table 1, it may be seen that the operation amount by a Huff-Edwards hybrid model may be more efficient. Furthermore, as described above, the shared secret curve calculation unit 400 may calculate a shared secret curve by performing the compression function w and the isogeny operation φ, to which the square-root Velu formula is applied (Equation 3), on the second public key PublicK_{B} received from the second encryption device using another Huff-Edwards hybrid model based on the secret key SecretK of the first encryption device 10 using the Huff-Edwards hybrid model of the present disclosure. In such a case, the generated shared secret curve may be the same value as the shared secret curve generated as the second encryption device 20 using another Huff-Edwards hybrid model may perform an isogeny operation φ on the first public key PublicK_{A} received from the first encryption device 10 using the Huff-Edwards hybrid model of the present disclosure.

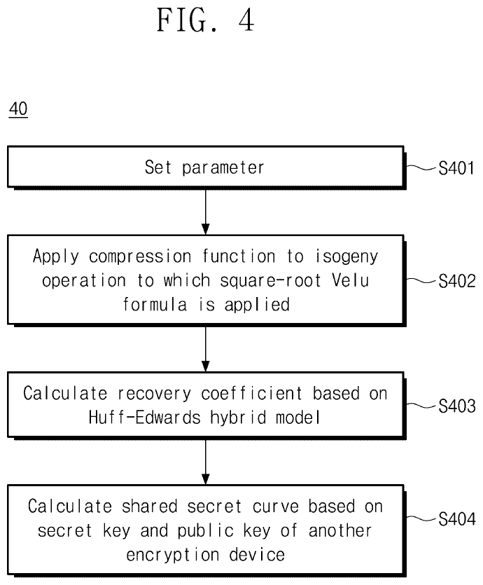

Hereinafter, an encryption method for using a Huff-Edwards hybrid model, according to an embodiment of the present disclosure, is described with reference to FIG. 4. FIG. 4 is a flowchart 40 of an encryption method using a Huff-Edwards hybrid model, according to an embodiment of the present disclosure.

Referring to FIG. 4, the parameter setting unit 100 may set an elliptic curve and a prime number, which may be parameters for encryption (operation S401). For example, the parameter setting unit 100 may set the one great prime number p and the Huff curve H_{c}. For example, the one great prime number p may be represented in a form of p=4·l₁·l₂· . . . lₙ−1, where lᵢ may be an odd prime number. The Huff curve H_{c} may be represented as an equation similar to Equation 1. c may represent the coefficient of the Huff curve H_{c}, and may be set to a value with a specific condition.

The public key calculation unit 200 may generate the public key of the first encryption device 10 by applying the compression function w̅ w to the isogeny operation φ for the Huff curve H_{c}, to which the square-root Velu formula is applied (operation S402). For example, the public key calculation unit 200 may calculate an equation similar to Equation 3 by using Equation 2, which may be a polynomial hₛ of a finite subset S of a kernel (P) of the isogeny operation φ and the compression function w for one point Q on the Huff curve H_{c} depending on the isogeny operation φ and the compression function w on the Huff curve H_{c} by using the square-root Velu formula. The public key calculation unit 200 may generate the image Huff curve H_{c′} by using an equation similar to Equation 3 thus calculated, may set the generated image Huff curve H_{c′} as a public key, and may share the public key with the second encryption device 20.

The coefficient recovery unit 300 may calculate a recovery coefficient based on a Huff-Edwards hybrid model (operation S403).

For example, the coefficient recovery unit 300 may recover the coefficient c′ of the image Huff curve H_{c′}, which may be the second public key PublicK_{B} received from the second encryption device 20.

The coefficient recovery unit 300 may calculate a recovery coefficient @ of the image Huff curve H_{c′} based on an equation similar to Equation 5 for calculating the recovery coefficient ĉ of the Huff curve H_{c} by using the coefficient c of the Huff curve H_{c}, an equation similar to Equation 6 for calculating the recovery coefficient [symbol] of the image Huff curve H_{c′} by using the coefficient c′ of the image Huff curve H_{c′}, an equation similar to Equation 7 for the relationship between the coefficient d of the Edwards curve E_{d} and the recovery coefficient [symbol] of the image Huff curve H_{c′}, and an equation similar to Equation 8 for the relationship between the coefficient d of the Edwards curve E_{d} and the recovery coefficient ĉ of the Huff curve H_{c}.

The shared secret curve calculation unit 400 may calculate a shared secret curve based on the second public key PublicK_{B} received from the second encryption device 20 and the secret key SecretK of the first encryption device 10 (operation S404). For example, the shared secret curve calculation unit 400 may calculate a shared secret curve by performing the compression function w and the isogeny operation φ, to which the square-root Velu formula is applied (e.g., an equation similar to Equation 3), on the second public key PublicK_{B} received from the second encryption device 20 using another Huff-Edwards hybrid model based on the secret key SecretK of the first encryption device 10 using the Huff-Edwards hybrid model.

Those skilled in the art to which the present disclosure pertains are to understand that the present disclosure may be embodied in other specific forms without changing the technical spirit or essential characteristics thereof.

Moreover, the methods described herein may be implemented at least partly by using one or more computer programs or components. The components may be provided as a series of computer instructions through a computer-readable medium or a machine-readable medium including volatile and nonvolatile memory. The instructions may be provided as software or firmware and may be implemented, in whole or in part, in hardware configurations such as, but not limited to, application-specific integrated circuits (ASICs), field programmable gate arrays (FPGAs), digital signal processors (DSPs), or other similar components. The instructions may be configured to be executed by one or more processors or other hardware configurations. When executing the series of computer instructions, the processor or other hardware configurations perform or enable to perform all or part of the methods and procedures disclosed herein.

Therefore, the above-described embodiments are examples in all aspects, and should be construed not to be restrictive. The scope of the present disclosure is defined by claims to be described below rather than the detailed description, and it should be interpreted that the scopes or claims of the present disclosure and all modifications or changed forms derived from the equivalent concept are included in the scopes of the present disclosure.

According to an embodiment of the present disclosure, an encryption device and a method thereof by using a Huff-Edwards hybrid model may improve the efficiency and performance of operations by optimizing encryption operations by combining fast and efficient operations in a Huff curve and an Edwards curve.

While the present disclosure has been described with reference to embodiments thereof, it is to be apparent to those of ordinary skill in the art that various changes and modifications may be made thereto without departing from the spirit and scope of the present disclosure as set forth in the following claims.

What is claimed is:

1. A first encryption device using a Huff-Edwards hybrid model, the first encryption device comprising:
one or more processors comprising processing circuitry; and
memory storing instructions,
wherein the instructions, when executed by the one or more processors individually or collectively, cause the first encryption device to:
set a plurality of encryption parameters comprising an elliptic curve and a prime number;
calculate a first public key to be shared with a second encryption device based on a secret key;
recover a coefficient of a second public key received from the second encryption device;
calculate a shared secret curve based on the secret key and the second public key;
set the elliptic curve to a Huff curve;
set the prime number to have a form of 4·l₁·l₂· . . . lₙ−1; lᵢ being an odd prime number, n being a positive integer greater than one, and i being a positive integer less than or equal to n;
calculate an isogeny operation by applying a compression function and a square-root Velu formula to the Huff curve;
recover, based on the Huff-Edwards hybrid model, a coefficient of an image Huff curve, the image Huff curve being the second public key; and
establish secure communication between the first encryption device and the second encryption device, based on the first public key and the second public key.

2. The first encryption device of claim 1, wherein the instructions, when executed by the one or more processors individually or collectively, further cause the first encryption device to:
optimize the compression function by using a polynomial representation of a finite subset of a kernel of the isogeny operation and a point compression function of a point on the Huff curve, based on the isogeny operation and the compression function on the Huff curve, and the square-root Velu formula;
generate the image Huff curve by using the optimized compression function;
set the image Huff curve to the first public key; and
share the first public key with the second encryption device.

3. The first encryption device of claim 1, wherein the instructions, when executed by the one or more processors individually or collectively, further cause the first encryption device to:
calculate the shared secret curve by performing the isogeny operation, to which the square-root Velu formula and the compression function is applied, based on the secret key with respect to the second public key.

4. The first encryption device of claim 1, wherein the instructions, when executed by the one or more processors individually or collectively, further cause the first encryption device to:
calculate an Edwards curve by performing an isomorphism operation, the Edwards curve being birationally equivalent to the Huff curve;
map the Edwards curve onto an image Edwards curve by using the isogeny operation; and
calculate the image Huff curve by performing the isomorphism operation, the image Huff curve being birationally equivalent to the mapped image Edwards curve.

5. The first encryption device of claim 1, wherein the instructions, when executed by the one or more processors individually or collectively, further cause the first encryption device to:
calculate a recovery coefficient of the second public key, by performing a composite function of mapping from the Huff curve to an Edwards curve, from the Edwards curve to an image Edwards curve, and from the image Edwards curve to the image Huff curve, the second public key being the image Huff curve.

6. The first encryption device of claim 1, wherein the instructions, when executed by the one or more processors individually or collectively, further cause the first encryption device to:
calculate a recovery coefficient of the second public key, the second public key being the image Huff curve, and
wherein the instructions, when executed by the one or more processors individually or collectively, further cause the first encryption device to:
calculate a recovery coefficient of the Huff curve based on a coefficient of the Huff curve;
calculate a recovery coefficient of the image Huff curve based on the coefficient of the image Huff curve;
calculate a first relationship between a coefficient of an Edwards curve and the recovery coefficient of the image Huff curve; and
calculate a second relationship between the coefficient of the Edwards curve and the recovery coefficient of the Huff curve.

7. The first encryption device of claim 1, wherein the instructions, when executed by the one or more processors individually or collectively, further cause the first encryption device to:
exchange, with the second encryption device, the first public key and the shared secret curve based on a commutative supersingular isogeny Diffie-Hellman (CSIDH) key exchange protocol.

8. An encryption method using a Huff-Edwards hybrid model to be performed by a first encryption device, the encryption method comprising:
setting a plurality of encryption parameters comprising an elliptic curve and a prime number;
calculating a first public key to be shared with a second encryption device, based on a secret key;
recovering a coefficient of a second public key received from the second encryption device;
calculating a shared secret curve based on the secret key and the second public key; and
establishing secure communication between the first encryption device and the second encryption device, based on the first public key and the second public key,
wherein the setting of the plurality of encryption parameters comprises:
setting the elliptic curve to a Huff curve; and
setting the prime number to have a form of 4·l₁·l₂· . . . lₙ−1, lᵢ being an odd prime number, n being a positive integer greater than one, and i being a positive integer less than or equal to n,
wherein the calculating of the first public key comprises:
calculating an isogeny operation by applying a compression function and a square-root Velu formula to the Huff curve, and
wherein the recovering of the coefficient of the second public key comprises:
recovering, based on the Huff-Edwards hybrid model, a coefficient of an image Huff curve, the image Huff curve being the second public key.

9. The encryption method of claim 8, wherein the calculating of the first public key comprises:
optimizing the compression function by using a polynomial representation of a finite subset of a kernel of the isogeny operation and a point compression function for a point on the Huff curve, based on the isogeny operation and the compression function on the Huff curve, and the square-root Velu formula;
generating the image Huff curve by using the optimized compression function;
setting the image Huff curve to the first public key; and
sharing the first public key with the second encryption device.

10. The encryption method of claim 8, wherein the calculating of the shared secret curve comprises:
calculating the shared secret curve by performing the isogeny operation, to which the square-root Velu formula and the compression function is applied, based on the secret key with respect to the second public key.

11. The encryption method of claim 8, wherein the recovering of the coefficient of the second public key comprises:
calculating a recovery coefficient of the second public key, the second public key being the image Huff curve, and
wherein the calculating of the recovery coefficient of the second public key comprises:
calculating a recovery coefficient of the Huff curve based on a coefficient of the Huff curve;
calculating a recovery coefficient of the image Huff curve based on the coefficient of the image Huff curve;
calculating a first relationship between a coefficient of an Edwards curve and the recovery coefficient of the image Huff curve; and
calculating a second relationship between the coefficient of the Edwards curve and the recovery coefficient of the Huff curve.

12. The encryption method of claim 11, wherein the calculating of the recovery coefficient of the second public key comprises:
calculating a recovery coefficient of the second public key, by performing a composite function of mapping from the Huff curve to the Edwards curve, from the Edwards curve to an image Edwards curve, and from the image Edwards curve to the image Huff curve, the second public key being the image Huff curve.

13. The encryption method of claim 8, further comprising:
calculating an Edwards curve by performing an isomorphism operation, the Edwards curve being birationally equivalent to the Huff curve;
mapping the Edwards curve onto an image Edwards curve by using the isogeny operation; and
calculating the image Huff curve by performing the isomorphism operation, the image Huff curve being birationally equivalent to the mapped image Edwards curve.

14. The encryption method of claim 8, further comprising:
exchanging, with the second encryption device, the first public key and the shared secret curve based on a commutative supersingular isogeny Diffie-Hellman (CSIDH) key exchange protocol.

15. An encryption system, the encryption system comprising:
a first encryption device using a first Huff-Edwards hybrid model; and
a second encryption device using a second Huff-Edwards hybrid model,
wherein the first encryption device is configured to:
set a plurality of encryption parameters comprising an elliptic curve and a prime number,
calculate a first public key to be shared with the second encryption device based on a secret key,
recover a coefficient of a second public key received from the second encryption device,
calculate a shared secret curve based on the secret key and the second public key, and
establish secure communication with the second encryption device, based on the first public key and the second public key,
wherein to set the plurality of encryption parameters comprises to:
set the elliptic curve to a Huff curve, and
set the prime number to have a form of 4·l₁·l₂· . . . lₙ−1, lᵢ being an odd prime number, n being a positive integer greater than one, and i being a positive integer less than or equal to n,
wherein to calculate the first public key comprises to calculate an isogeny operation by applying a compression function and a square-root Velu formula to the Huff curve, and
wherein to recover the coefficient of the second public key comprises to recover, based on the first Huff-Edwards hybrid model, a coefficient of an image Huff curve, the image Huff curve being the second public key.

16. The encryption system of claim 15, wherein the first encryption device is further configured to:
optimize the compression function by using a polynomial representation of a finite subset of a kernel of the isogeny operation and a point compression function of a point on the Huff curve, based on the isogeny operation and the compression function on the Huff curve, and the square-root Velu formula;
generate the image Huff curve by using the optimized compression function;
set the image Huff curve to the first public key; and
share the first public key with the second encryption device.

17. The encryption system of claim 15, wherein the first encryption device is further configured to:
calculate the shared secret curve by performing the isogeny operation, to which the square-root Velu formula and the compression function is applied, based on the secret key with respect to the second public key.

18. The encryption system of claim 15, wherein the first encryption device is further configured to:
calculate an Edwards curve by performing an isomorphism operation, the Edwards curve being birationally equivalent to the Huff curve;
map the Edwards curve onto an image Edwards curve by using the isogeny operation; and
calculate the image Huff curve by performing the isomorphism operation, the image Huff curve being birationally equivalent to the mapped image Edwards curve.

19. The encryption system of claim 15, wherein the first encryption device is further configured to:
calculate a recovery coefficient of the second public key, by performing a composite function of mapping from the Huff curve to an Edwards curve, from the Edwards curve to an image Edwards curve, and from the image Edwards curve to the image Huff curve, the second public key being the image Huff curve.

20. The encryption system of claim 15, wherein the first encryption device is further configured to:
calculate a recovery coefficient of the second public key, the second public key being the image Huff curve, and
wherein to calculate the recovery coefficient of the second public key comprises to:
calculate a recovery coefficient of the Huff curve based on a coefficient of the Huff curve;
calculate a recovery coefficient of the image Huff curve based on the coefficient of the image Huff curve;
calculate a first relationship between a coefficient of an Edwards curve and the recovery coefficient of the image Huff curve; and
calculate a second relationship between the coefficient of the Edwards curve and the recovery coefficient of the Huff curve.
